(19) United States
(12) Patent Application Publication
(10) Pub. No.: US 2018/0183189 A1
(43) Pub. Date: Jun. 28, 2018

(54) BOARD TO BOARD CONNECTOR ASSEMBLY WITH SANDWICHING TYPE SHIELDING PLATE SET

(71) Applicant: FOXCONN INTERCONNECT TECHNOLOGY LIMITED, Grand Cayman (KY)

(72) Inventor: SHUN-JUNG CHUANG, New Taipei (TW)

(21) Appl. No.: 15/854,833

(22) Filed: Dec. 27, 2017

(30) Foreign Application Priority Data
Dec. 28, 2016 (CN) 201611237266.3

(51) Int. Cl. H01R 13/6585; H01R 12/71; H01R 13/41

(52) U.S. Cl. CPC H01R 13/6585; H01R 13/41; H01R 12/716

(57) ABSTRACT

The receptacle connector includes an insulative housing, a plurality of contacts retained in the housing, and a metallic shielding shell covering the housing. The housing includes a base and an island extending upwardly from the base, and a peripheral wall surrounding the island and forming a tubular receiving cavity. The contacts includes two rows of contacts retained to the island. The shielding shell is retained to the peripheral wall. A pair of metallic shielding plates are retained in the island and between two rows of contacts. The plug connector includes an insulartive housing, a plurality of contacts retained to the housing, and a metallic shielding shell attached upon the housing. The housing includes a base and a circumferential wall forming a mating cavity. A metallic shielding plate is disposed in the mating cavity.

### FIELD OF THE DISCLOSURE

The invention is related to an electrical connector assembly, and particularly to the board-to-board connector with sandwiching type shielding plate set.

### DESCRIPTION OF RELATED ARTS

China Utility Patent No. CN201072831Y discloses a board-to-board connector having an insulative housing with two rows of contacts and a metallic shell enclosing the housing. The housing includes a base and an island extending from the base, on which two rows of the contacts are exposed, wherein a circumferential mating groove surrounds the island. Anyhow, an Electro-Magnetic Interference (EMI) may occur between two rows of contacts.

An electrical connector with not only the exterior shield and the interior shield is desired.

### SUMMARY OF THE DISCLOSURE

An electrical board-to-board connector assembly includes a receptacle connector and a plug connector mated with each other. The receptacle connector includes an insulative housing, a plurality of contacts retained in the housing, and a metallic shielding shell covering the housing. The housing includes a base and an island extending upwardly from the base, and a peripheral wall surrounding the island and forming a tubular receiving cavity. The contacts includes two rows of contacts retained to the island. The shielding shell is retained to the peripheral wall. A pair of metallic shielding plates are retained in the island and between two rows of contacts. The plug connector includes an insulartive housing, a plurality of contacts retained to the housing, and the shielding shell attached upon the housing. The housing includes a base and a circumferential wall forming a mating cavity. A metallic shielding plate is disposed in the mating cavity. During mating, the circumferential wall is received within the tubular receiving cavity, and the island is received within the mating cavity so as to have the shielding blade of the plug connector is sandwiched between the pair of shielding plates.

### BRIEF DESCRIPTION OF THE DRAWINGS

FIG. 1 is a perspective view of the electrical connector assembly of the invention including the mated receptacle connector and plug connector;

FIG. 2 is another perspective view of the electrical connector assembly of FIG. 1;

FIG. 3 is an exploded perspective view of the receptacle electrical connector of the electrical connector assembly of FIG. 1;

FIG. 4 is another exploded perspective view of the receptacle electrical connector of FIG. 3;

FIG. 5 is an exploded perspective view of the plug connector of the electrical connector assembly of FIG. 1;

FIG. 6 is another exploded perspective view of the plug connector of FIG. 5;

FIG. 7 is a cross-sectional view of the electrical connector assembly of FIG. 1 wherein the receptacle connector and the plug connector are unmated with each other; and

FIG. 8 is a cross-sectional view of the electrical connector assembly of FIG. 1 wherein the receptacle connector and the plug connector are mated with each other.

### DETAILED DESCRIPTION OF THE PREFERRED EMBODIMENT

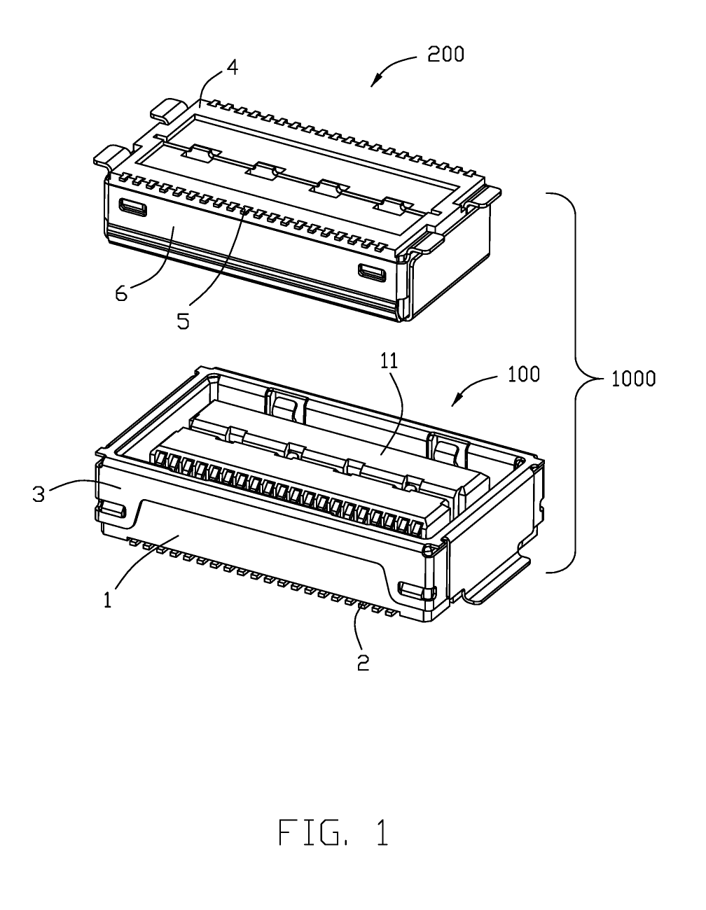

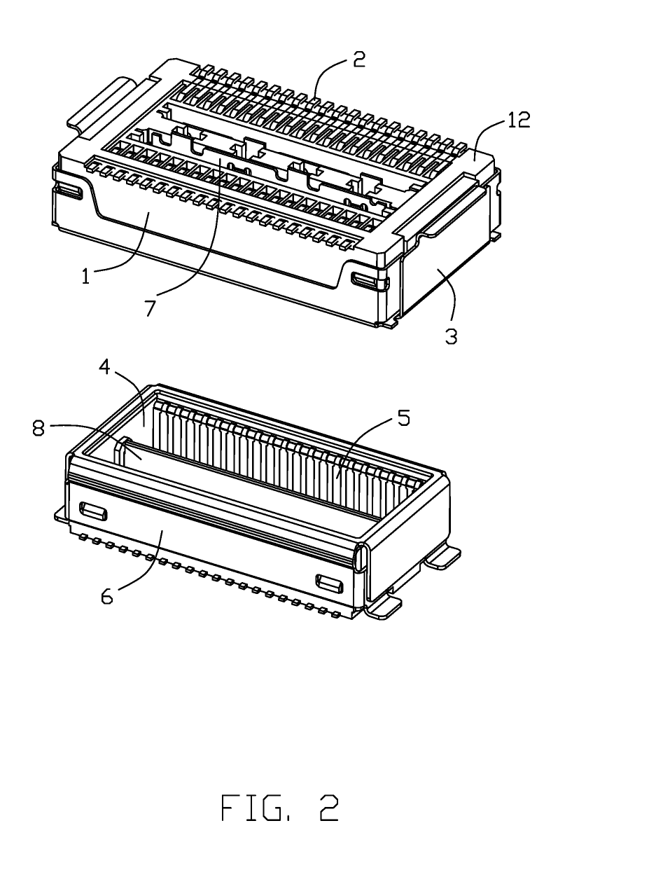

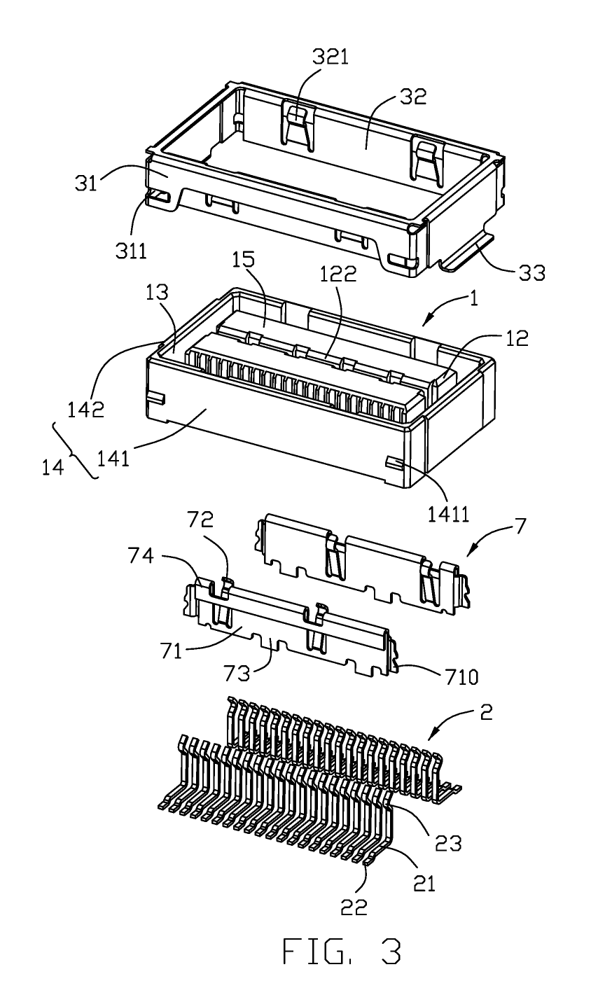

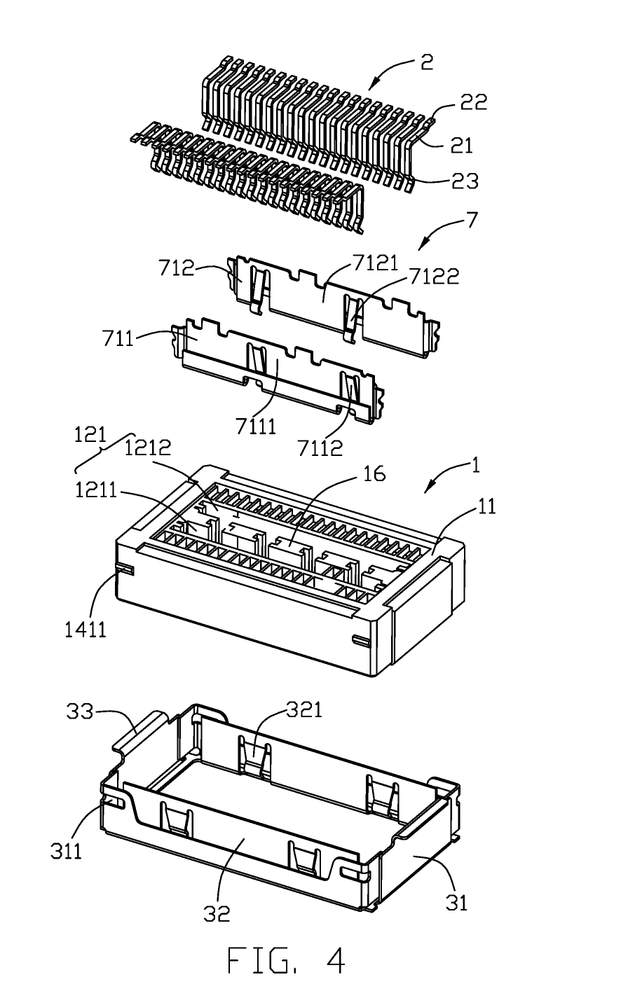

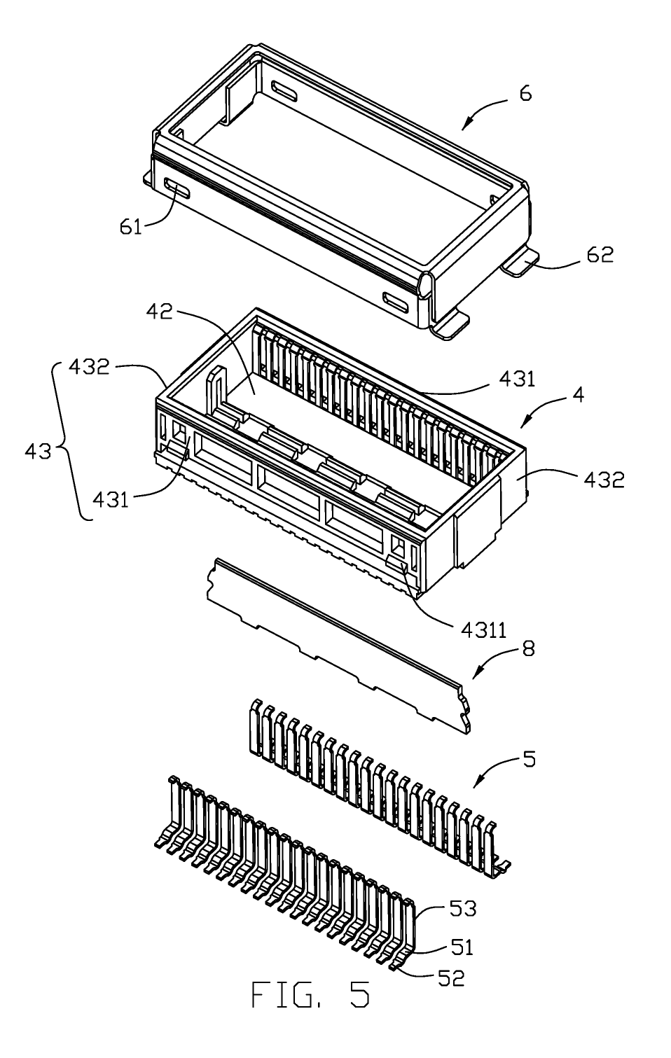

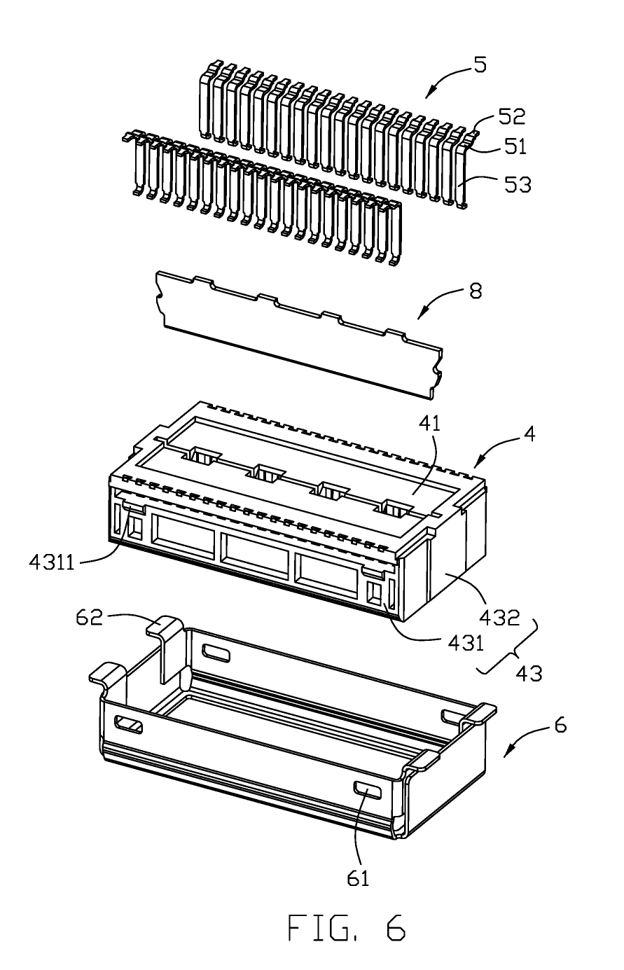

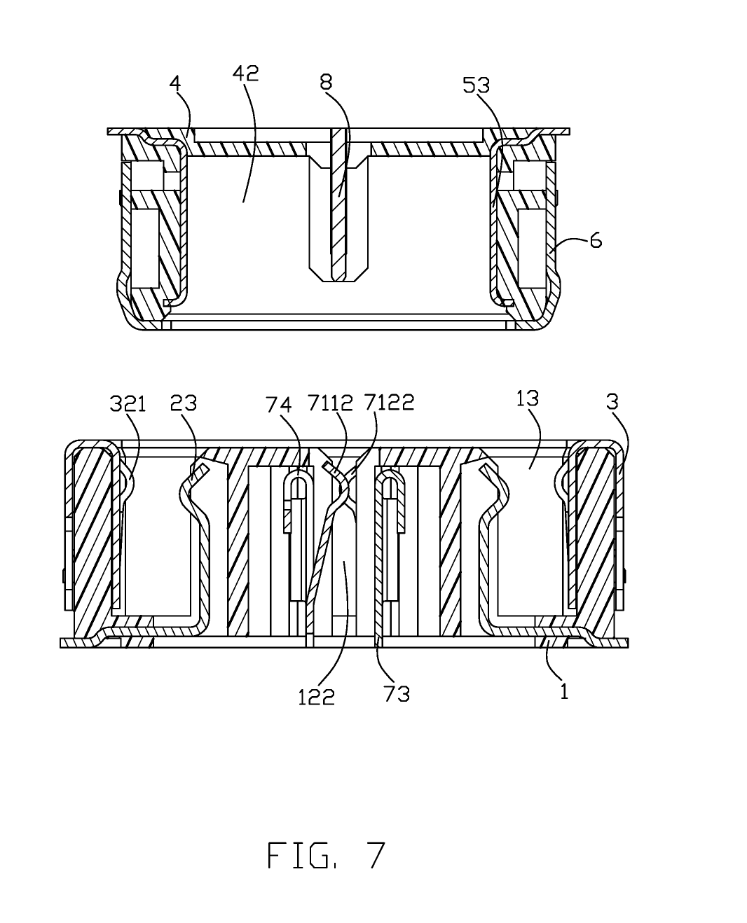

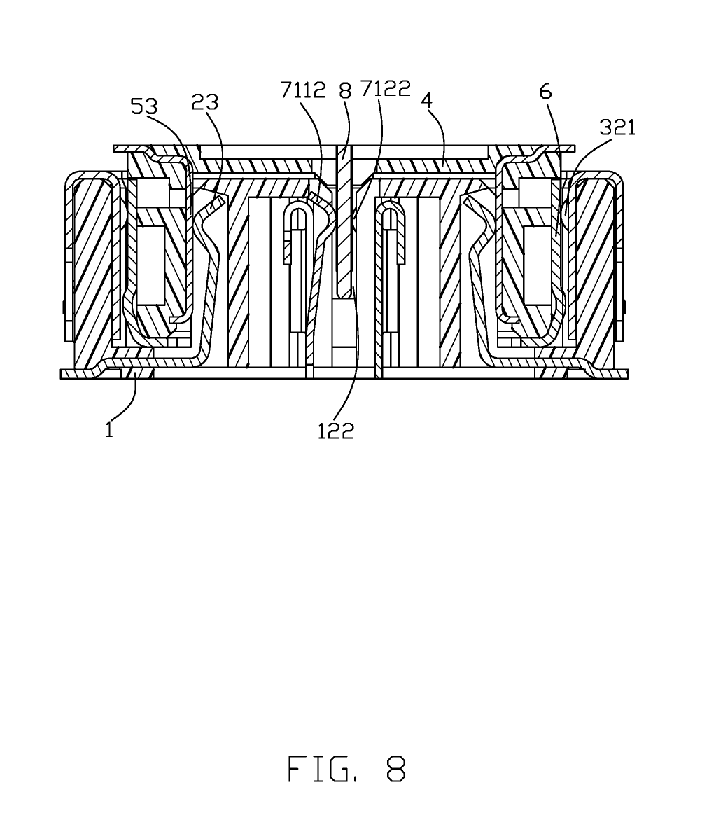

Reference will now be made in detail to the embodiments of the present disclosure. Referring to FIGS. 1-8, an electrical connector assembly 1000 is essentially a board-to-board connector set including a receptacle connector 100 mounted upon one printed circuit board (not shown), and a plug connector 200 mounted upon another printed circuit board (not shown). The receptacle connector 100 includes an insulative housing 1, a plurality of contacts 2 retained to the housing 1, and a metallic shield 3 covering the housing 1. The plug connector 200 includes an insulative casing 4, a plurality of terminals 5 retained to the casing, and a metallic shell 6 enclosing the casing 4.

In the receptacle connector 100, the housing 1 includes a base 11 and an island 12 extending from the base 11, and a peripheral wall 14 surrounding the island 12 to form a tubular receiving cavity 13 therebetween. The contacts 2 are arrange with two rows. The peripheral wall 14 includes a pair of long side walls 141 and a pair of short side walls 142. The shield 3 covers both the side walls 141 and the side walls 14 continuously. The shield 3 further includes the inner part 32 extending from the outer part 31 and covering the interior face 1411 of the first side wall 141 with a plurality of spring tangs 321 extending into the tubular receiving cavity 13. The two rows of contacts 2 are respectively disposed upon two opposite sides of the island 12 directing to the corresponding long side walls 141. Each contact 2 includes a retaining section 21, a soldering section 23 extending from the retaining section 21 an exposed outside of the long side wall 141, and a resilient contacting section 23 extending from the retaining section 21 and exposed upon the island 12 and extending into the tubular receiving cavity 13. The shield 3 further includes a pair of soldering legs 33 by two short side walls 142. The long side wall 141 forms blocks 1411 engaged within the holes 311 of the shield 3.

In the plug connector 200, the insulative casing 4 includes a base 41 and a circumferential wall 43 extending upwardly from the base 41 to form a mating cavity 42. The terminals 5 are arranged with two rows. The casing includes a pair of large walls 431 and a pair of small walls 432. The shell 6 forms holes 61 to receive the corresponding blocks 4311 formed on the large side wall 431 for securing the shell 6 to the casing 4. The terminals 5 includes a retaining portion 51 retained to the casing 4, a soldering portion 52 extending from the retaining portion 51 and outside of the large side wall 431, and a planar contacting portion 53 extending from the retaining portion 51 and exposed upon the an interior surface of the large side wall 431. The shell 6 further includes a pair of soldering pads 62 by two sides of the small side walls 421.

Notably, during mating the island 12 is inserted into the mating cavity 42 and the circumferential wall 43 is received within the tubular receiving cavity 13. The contacting sections 23 connect to the corresponding contacting portions 53. The spring tangs 321 abut against the shell 6. The shielding effect is perfected due to the continuous surrounding/shielding structure on each connector.

The feature of the invention is to provide the anti-EMI structures between the receptacle connector 100 and the plug connector 200. The receptacle connector 100 further includes a pair of shielding plates 7 assemble within the island 12 to separate the two rows of contacts 2 in the transverse direction. In another embodiment, the pair of shielding plates 7 may be unitarily formed as one piece. The plug connector 200 further includes a shielding blade 8 assembled to the base 41 and extending into the mating cavity 42 to separate the two rows of terminals 5. During mating, the shielding blade 8 is sandwiched between the pair of shielding plates 7 so as to efficiently isolate the mated contacts 2 and terminals 5 on one side of the island 12 from those on the other side. In this embodiment, the island 12 includes a pair of retention slots 121, i.e., the first retention slot 1211 and the second retention slot 1212, and an insertion slot 122 communicatively between the pair of retention slots 121. The island 12 housing 1 further includes a top face 15 and a bottom face 16. The retention slots 121 extend from the bottom face 16 and terminates before reaching the top face 15 while the insertion slot 122 extends through both the top face 15 and the bottom face 16. The shielding plate 7 includes a retention section 71 retained in the retention slot 121 and a spring finger 72 extending into the insertion slot 122. The retention section 71 includes interference sides 710 engaged within the retention slot 121. The shielding plate 7 forms a mounting side and an insertion side opposite to each other, and includes the soldering legs 73 on the mounting side. The shielding plate 7 further includes an arc section 74 at the top opposite to the mounting side in the vertical direction and opposite to the spring fingers 72 in the transverse direction, One shielding plate 7 includes the first shielding part 711 includes a planar first retention section 7111 retained in the first retention slot 1211, and a first abutment section 7112 extending from the first retention section 7111 into the insertion slot 122. Similarly, the other shielding plate 7 includes a second shielding part 712 includes a planar second retention section 7121 retained in the second retention slot 1212, and a second abutment section 7122 extending from the second retention section 7121 into the insertion slot 122.

During mating, the shielding blade 8 is inserted into the insertion slot 122 and sandwiched by the first abutment section 7112 of the first shielding part 711 and the second abutment section 7122 of the second shielding part 712 in the transverse direction. In this embodiment, the lengthwise dimension of the shielding plate 7 and the shielding blade 8 are similar to the dimension of the housing 1 and the casing 4, and during mating, the height of the connected shielding plate 7 and shielding blade 8 is similar to the assembled housing 1 and casing 4, thus assuring reliable shielding effect thereabouts.

Another feature of the invention is regarding the shield 3 having top frame structure to cover the top face of the housing 1, and the outer part 4 extends downwardly from four edges of the frame structure. The shell 6 is also configured as well.

While a preferred embodiment according to the present disclosure has been shown and described, equivalent modifications and changes known to persons skilled in the art according to the spirit of the present disclosure are considered within the scope of the present disclosure as described in the appended claims.

What is claimed is:

1. An electrical receptacle connector comprising:
an insulative housing including a horizontal base, an island and a peripheral wall commonly extending upwardly from the base in a vertical direction, the peripheral wall surrounding the island to form a tubular receiving cavity therebetween;
an insertion slot formed in the island and extending through a top face of the island;
a metallic shield retained to the housing and surrounding and covering the peripheral wall;
two rows of contacts retained in the housing with corresponding resilient contacting sections exposed upon two opposite sides of island and further into the receiving cavity in a transverse direction perpendicular to said vertical direction; and
a pair of metallic shielding plates retained in the island and located by two opposite sides of the insertion slot in the transverse direction, wherein each of said shielding plate includes a spring finger extending into the insertion slot.

2. The electrical receptacle connector as claimed in claim 1, wherein the island forms a pair of retention slots by two sides of the insertion slot in the transverse direction to receive the pair of shielding plates, respectively.

3. The electrical receptacle connector as claimed in claim 1, wherein each of the shielding plates includes an upside-down U-shaped structure at a top.

4. The electrical receptacle connector as claimed in claim 1, wherein the shield includes a plurality of spring tangs extending into the receiving cavity opposite to the corresponding contacting sections in the transverse direction.

5. The electrical receptacle connector as claimed in claim 4, wherein the shield includes an outer part covering an exterior surface of the housing, and an inner part covering an interior surface of the housing facing toward the receiving cavity, and the spring tangs extend from the inner part.

6. The electrical receptacle connector as claimed in claim 5, wherein said spring tangs extend upwardly in compliance with the resilient contacting sections which extend upwardly.

7. An electrical plug connector comprising:
an insulative casing including a base and a circumferential wall upwardly extending from the base in a vertical direction to commonly form a rectangular mating cavity therein;
a metallic shell enclosing the case;
two rows of terminals retained to the casing with corresponding planar contacting portions exposed upon corresponding inner surfaces of two large side walls of the casing and facing toward the mating cavity and further toward each other in a transverse direction perpendicular to the vertical direction; and
a metallic shielding blade retained to the casing and exposed in a center line of said mating cavity in the transverse direction.

8. The electrical plug connector as claimed in claim 7, wherein said shielding blade separates said mating cavity into two halves in the transverse direction.

9. An electrical connector assembly comprising:
a receptacle connector adapted to be mated with a plug connector,
said receptacle connector including:
an insulative housing
an insulative housing including a horizontal base, an island and a peripheral wall commonly extending upwardly from the base in a vertical direction, the peripheral wall surrounding the island to form a receiving cavity therebetween;
an insertion slot formed in the island and extending through a top face of the island;
a metallic shield retained to the housing and surrounding and covering the peripheral wall;
two rows of contacts retained in the housing with corresponding contacting sections exposed upon two opposite sides of island and further into the receiving cavity in a transverse direction perpendicular to said vertical direction;
a pair of metallic shielding plates retained in the island and located by two opposite sides of the insertion slot in the transverse direction; and
said plug connector including:
an insulative casing including a base and a circumferential wall upwardly extending from the base in said vertical direction to commonly form a rectangular mating cavity therein;
a metallic shell enclosing the casing;
two rows of terminals retained to the casing with corresponding contacting portions exposed upon corresponding inner surfaces of two large side walls of the casing and facing toward the mating cavity and further toward each other in said transverse direction;
a metallic shielding blade retained to the casing and exposed in a center line of said mating cavity in the transverse direction; wherein
during mating, the contacting sections of the contacts connect to the contacting portions of the terminals, the circumferential wall is received within the receiving cavity, and the shielding blade is sandwiched between the the pair of shielding plates, and spring fingers are formed on at least one of the shielding plate and the shielding blade to contact the other for mechanical and electrical connection therebetween.

10. The electrical connector assembly as claimed in claim 9, wherein the spring fingers are formed on the shielding plate.

11. The electrical connector assembly as claimed in claim 9, wherein said contacting sections are resilient and the contacting portions are stationary.

12. The electrical connector assembly as claimed in claim 11, wherein the shield includes an inner part to cover an interior surface of the housing, and spring tangs extend from the inner part into the receiving cavity in the transverse direction.

13. The electrical connector assembly as claimed in claim 12, wherein said spring tangs extend upwardly.

14. The electrical connector assembly as claimed in claim 13, wherein said spring fingers are formed on the shielding plate and extend upwardly.
